(19) United States
(12) Patent Application Publication
(10) Pub. No.: US 2015/0327588 A1
(43) Pub. Date: Nov. 19, 2015

(54) A METHOD AND APPARATUS FOR INCREASING THE SOLUBILITY OF FAT-SOLUBLE NUTRIENT IN WATER

(71) Applicant: KONINKLIJKE PHILIPS N.V., EINDHOVEN (NL)

(72) Inventors: MO LI, EINDHOVEN (NL); MEI SHI, EINDHOVEN (NL)

(21) Appl. No.: 14/411,133

(22) PCT Filed: Jun. 24, 2013
(86) PCT No.: PCT/IB2013/055158

§ 371 Date: Dec. 24, 2014

(30) Foreign Application Priority Data
Jul. 3, 2012 (CN) PCT/CN2012/000916

(51) Int. Cl. A23L 1/30; A23L 2/52

(52) U.S. Cl. CPC A23L 1/3006; A23L 2/52

(57) ABSTRACT

The invention is about a method of increasing the solubility of fat-soluble nutrient in water. The method comprises a step (1 1) of increasing the pH of water to generate alkaline water with a pH of at least about 8.0; a step (12) of mixing the water with an edible oil to generate surfactant-containing water; a step (13) of adjusting the pH of the surfactant-containing water to a predetermined range; and a step (14) of combining the surfactant-containing water and substance containing the fat-soluble nutrient to produce food or drink. An apparatus for conducting the method is also provided.

### FIELD OF THE INVENTION

The present invention generally relates to a method and to an apparatus for processing water.

Particularly, the present invention relates to a method and an apparatus for increasing the solubility of fat-soluble nutrient in water.

### BACKGROUND OF THE INVENTION

It is known that it is not beneficial to health if too much edible oils are consumed. For example, if edible oils are consumed excessively, the risk of heart attack is increased. Thus it is desirable to reduce the consumption amount of edible oil now days. However, it is also known that sometimes it is necessary to use oils to dissolve fat-soluble nutrient or extract fat-soluble nutrient from food or other substances. If edible oils are used at very low levels, the dissolution or extraction of fat-soluble nutrient may be insufficient. The insufficient dissolution or extraction may in turn reduce the intake of such fat-soluble nutrient. It is desirable to use less edible oil while maintaining the dissolution or extraction of fat-soluble nutrient.

It is known surfactants are compounds that can lower the surface tension of a liquid, the interfacial tension between two liquids, or that between a liquid and a solid.

### SUMMARY OF THE INVENTION

A surfactant molecule contains both a water insoluble (or an oil soluble) portion and a water soluble portion. Surfactant molecules will diffuse in water and adsorb at interfaces between air and water, or at the interface between oil and water, in the case where water is mixed with oil. The water insoluble hydrophobic portion of surfactant may extend out of the bulk water phase, into the air or into the oil phase, while the water soluble head portion remains in the water phase. This alignment of surfactant molecules at the surface modifies the surface properties of water at the water/air or water/oil interface.

Due to the distinctive structure of surfactants, surfactants can be used to increase the solubility of fat-soluble materials such as fat-soluble nutrient in water. For example, in the presence of surfactants, fat-soluble nutrient can be transferred from food or other substances (e.g. edible ingredients) into water. Thus the amount of oil necessary to dissolve or extract fat-soluble nutrient from food or other substances can be greatly reduced or even the use of oil can be avoided. As mentioned above, sometimes the reduced amount of edible oil is advantageous for health.

In the following, food or other substances will be only referred to as substance.

However, surfactant is not readily available domestically. It is desirable to develop a simple and convenient method for producing surfactants from raw materials commonly used in kitchen, for example from edible oils. The resultant surfactants in turn can help to dissolve fat-soluble nutrient or increase the solubility of fat-soluble nutrient in water.

The present invention provides such a simple and convenient method.

According to an aspect of present invention, the present invention relates to a method of increasing the solubility of fat-soluble nutrient in water, comprising the steps of:
increasing the pH of water to generate alkaline water with a pH of at least about 8.0;
mixing the water with an edible oil to generate surfactant-containing water: this step can be done before or after the increasing step;
adjusting the pH of the surfactant-containing water to a predetermined range; and
combining the surfactant-containing water and substance containing the fat-soluble nutrient to produce (i.e. cook, prepare) food or drink: this step can be done before or after the adjusting step.

According to an embodiment of present invention, the method of increasing the solubility of fat-soluble nutrient in water of present invention comprises the steps of:
increasing the pH of water to generate alkaline water with a pH of at least about 8.0;
mixing the alkaline water with an edible oil to generate surfactant-containing water;
adjusting the pH of the surfactant-containing water to a predetermined range; and
combining the surfactant-containing water and substance containing the fat-soluble nutrient to produce (i.e. cook, prepare) food or drink.

According to another embodiment of present invention, the method of increasing the solubility of fat-soluble nutrient in water of present invention comprises the steps of:
electrolyzing water to generate alkaline water with a pH of at least about 8.0 and acidic water;
mixing the alkaline water with an edible oil to generate surfactant-containing water;
adjusting the pH of the surfactant-containing water to a predetermined range by using the generated acidic water; and
combining the surfactant-containing water and substance containing the fat-soluble nutrient to produce (i.e. cook, prepare) food or drink: this step can be done before or after the adjusting step.

In the method of present invention, due to the presence of surfactants in water, the amount of edible oil used can be reduced to a very low level and at the same time the dissolving or extracting of fat-soluble nutrient is not impaired. The food or drink produced by the method of present invention comprises a substantial amount of dissolved or extracted fat-soluble nutrient although a small amount of edible oils is used. Further the method of present invention is very simple and can be conducted easily, as illustrated in the present invention.

According to another aspect of present invention, an apparatus for increasing the solubility of fat-soluble nutrient in water is provided, comprising:
a vessel for mixing alkaline water having pH of at least about 8.0 with an edible oil to generate surfactant-containing water;
a pH controlling unit comprising a processor and a pH meter; and
a first controller connected to the pH controlling unit for controlling the supply of acidic water, alkaline water, a food compatible acidic substance and/or a food compatible basic substance into the vessel.

### BRIEF DESCRIPTION OF THE DRAWINGS

FIG. 1 shows a flow chart according to an embodiment of the method of the present invention.

FIG. 2 shows a flow chart according to another embodiment of the method of the present invention.

FIG. 3 show a schematic diagram according to an embodiment of the apparatus of present invention.

### DETAILED DESCRIPTION OF THE INVENTION

The present invention will be described with respect to particular embodiments and with reference to certain drawings but the invention is not limited thereto but only by the claims. Any reference signs in the claims shall not be construed as limiting the scope. The drawings described are only schematic and are non-limiting. Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated.

Furthermore, the terms first, second, third and the like in the description and in the claims, are used for distinguishing between similar elements and not necessarily for describing a sequential or chronological order.

Generally, the method of present invention is a method of processing water for increasing the solubility of fat-soluble nutrient in water.

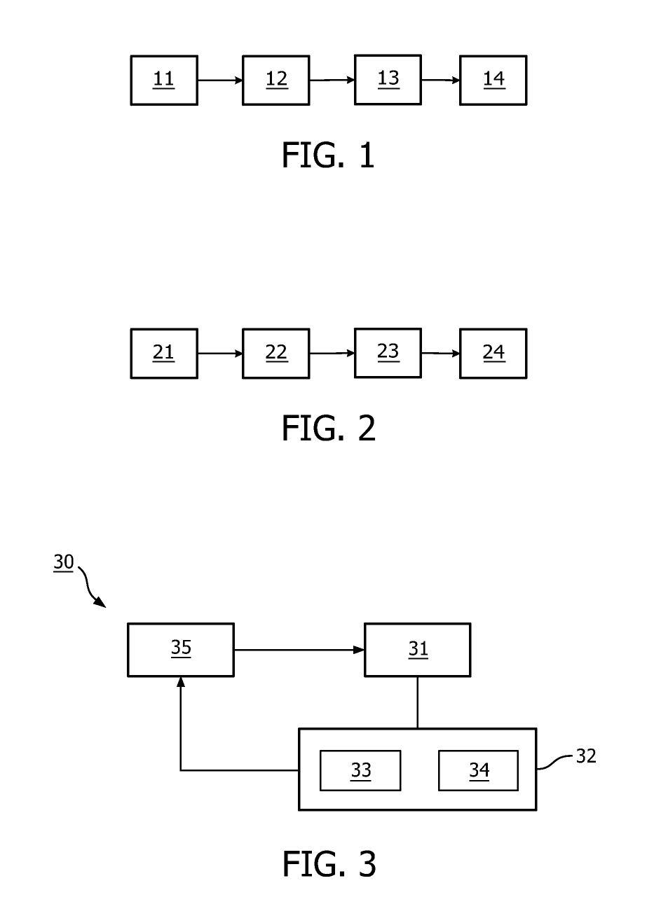

FIG. 1 is a flow chart showing an embodiment of the method of present invention.

According to an embodiment of present invention, the method of increasing the solubility of fat-soluble nutrient in water of present invention comprises the steps of:
increasing 11 the pH of water to generate alkaline water with a pH of at least about 8.0;
mixing 12 the water with an edible oil to generate surfactant-containing water: this step can be done before or after the pH increasing step;
adjusting 13 the pH of the surfactant-containing water to a predetermined range; and
combining 14 the surfactant-containing water and substance containing the fat-soluble nutrient to produce (i.e. cook, prepare) food or drink: this step can be done before or after the pH adjusting step.

According to the present invention, there are no particular limits to the water to be used to generate the alkaline water. Generally, any water that can be employed to produce food or drink can be used. For example, the water to be used to generate the alkaline water can be any water that can be drunk directly by people. For example, the water used to generate the alkaline water can include, but not limited to, tap water, mineral water, purified water, deionized water, and so on.

In the context of present invention, the term “fat-soluble” is interchangeable with the term “oil soluble” and has a meaning commonly used and widely understood in the art.

In the context of present invention, the expression “food or drink compatible” means being acceptable in food or drink.

In the context of present invention, the alkaline water is water which is basic at room temperature. For example, the alkaline water can have a pH of at least about 8.0, preferably at least about 8.5, more preferably at least about 9.0, more preferably at least about 9.5, or even preferably at least about 10.0. Although there is no particular limit to the upper limit of the pH of the alkaline water, the pH of the alkaline water can be not more than about 14, preferably not more than about 13, preferably not more than about 11, and more preferably not more than about 11. A desirable pH range of the alkaline water can be obtained by combining a lower limit mentioned above and an upper limit mentioned above. For example, the alkaline water can have a pH of from about 8.0 to about 14, from about 8.5 to about 13, from about 9.0 to about 14, from about 9.0 to about 13, from about 9.0 to about 12, or from about 9.0 to about 11. A person skilled in the art can determine the pH of the alkaline water easily and appropriately, provided sufficient surfactants can be produced.

In the method of present invention, pH values are measured where necessary to determine if the required pH is provided. Those skilled in the art know how to determine the pH and there are various ways to determine the pH. For example, the pH value can be determined by using a pH indicator, a pH test paper or a pH meter.

According to an embodiment, the step of increasing 11 the pH of water to generate alkaline water is carried out by adding a food or drink compatible basic substance into said water. According to an embodiment, the food or drink compatible basic substance can include, but not limited to, soda (Na₂CO₃), baking soda (NaHCO₃) or a combination thereof. However, as will be understood by those skilled in the art, generally any food or drink compatible basic substances can be used provided that the required alkaline water can be generated.

According to another embodiment, the step of increasing 11 the pH of water to generate alkaline water is carried out by electrolyzing the water.

Devices for producing alkaline water and/or acidic water by means of electrolysis of water have already been developed and are well known to those skilled in the art. Sometimes such devices can be referred to as water electrolyzers. This device, designed to subject water to electrolysis, includes an electrolytic cell having an anode and a cathode. As a direct electric potential is applied between the electrodes, the hydroxyl ions OH⁻ being present in water due to electrolytic dissociation of water molecules will donate electrons to the anode at the anode-water interface and are thereby oxidized to form oxygen gas which is then removed away from the system. As a result, the H⁺ concentration is enhanced at the anode-water interface so that H⁺ enriched acidic water is resulted at the anode-water interface. At the cathode-water interface, on the other hand, H⁺ accepts electron from the cathode and is reduced to hydrogen to form hydrogen gas which is similarly eliminated from the system. As a result, the OH⁻ concentration is increased whereby OH⁻ enriched alkaline water is generated at the cathode side. The method of present invention can use alkaline water produced by any suitable devices for electrolyzing water, provided the alkaline water has a desired pH.

According to an embodiment, in the method of present invention, after the pH increasing step 11, a step of mixing 12 the water (i.e. the alkaline water) with an edible oil to generate surfactant-containing water is conducted.

According to an embodiment, the mixing 12 of the alkaline water and the edible oil can be performed at ambient temperature, either at atmospheric pressure or elevated pressure.

According to another embodiment, the mixing 12 of the alkaline water and the edible oil can be conducted at an elevated temperature, either at atmospheric pressure or elevated pressure. It is believed that a higher temperature can accelerate the generation of surfactants. For example, the mixing can be carried out at a temperature of at least about 40° C., at least about 50° C., at least about 60° C., at least 70° C., at least about 80° C., or at least about 90° C. According to a particular embodiment, the mixing is carried out at a temperature of from about 40° C. to boiling temperature, preferably from about 50° C. to boiling temperature, preferably from about 60° C. to boiling temperature, preferably from about 70° C. to boiling temperature, preferably from about 80° C. to boiling temperature, preferably from about 90° C. to boiling temperature.

According to an embodiment, the mixing 12 of the alkaline water and the edible oil can be carried out for about 0.1 minute to about 12 hours, preferably about 1 minute to about 6 hours, preferably about 3 minute to about 4 hours, and more preferably about 5 minute to about 2 hours. Those skilled in the art can properly determine the period required, provided that sufficient surfactants are generated.

According to an embodiment, the mixing 12 of the water and the edible oil can be conducted with stirring. For example, the stirring can be performed either by hand or by a stirrer.

According to an embodiment of present invention, when the step of increasing the pH of water to generate alkaline water is carried out by adding a food or drink compatible basic substance into said water, the addition of the food or drink compatible basic substance can be conducted before, after or simultaneously with the edible oil. For example, the edible oil can be mixed with the water firstly and then the food or drink compatible basic substance can be added therein. There are no limits to the addition sequence of the food or drink compatible basic substance and the edible oil, provided that the surfactant-containing water can be obtained.

Edible oils used in present invention can be any oil that can be consumed by human being. It is well known that edible oils comprise mainly triglycerides. However, as will be understood by those skilled in the art, oils comprise monoglyceride(s) and/or diglyceride(s) in addition to triglycerides or oils comprise mainly monoglyceride(s) and/or diglyceride(s) can also be used. Generally the edible oil can be selected from vegetable oils and animal oils commonly consumed by people, such as those used in making food or drink or used for cooking.

According to an embodiment, said vegetable oil includes, but no limited to, soybean oil, peanut oil, olive oil, corn oil, sunflower seed oil, castor oil, cottonseed oil, coconut oil, rape seed oil, tea-seed oil, coconut oil or a combination thereof. According to an embodiment, said animal oil can include, but not limited to, lard, tallow, mutton tallow, chicken oil, duck oil, whale oil, and fish oil or a combination thereof.

Without to be limited by any theory, it is believed that the surfactants in said surfactant-containing water are produced via the reaction between glyceride and hydroxyl ion OH⁻, as illustrated by the following equation (taking a triglyceride containing the same R groups as an example):

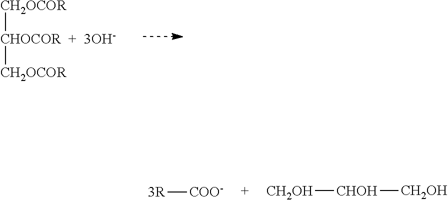

The reaction product, R—COO⁻, is a surfactant, which can be used to dissolve or increase the solubility of fat-soluble nutrient in water.

In above equation, it is illustrated that the triglyceride is completely hydrolyzed. However, as will be understood by those skilled in the art, triglyceride or diglyceride may also be partially hydrolyzed.

Although the method of present invention is described by using the term “edible oil”, edible fats can also be used in said method. It is known that an edible fat, similar to edible oils, comprises mainly triglycerides. The edible fat, when heated at an elevated temperature, will melt and become a liquid (an oil). When an edible fat is used in the method of present invention, the surfactant-containing water can also be generated.

Generally, in the method of present invention, the ratio of the water to the edible oil is at least about 50:1 by volume, preferably at least about 60:1, preferably at least about 70:1, preferably at least about 80:1, preferably at least about 90:1, preferably at least about 100:1, preferably at least about 150:1, preferably at least about 200:1, or preferably at least about 300:1. Generally, the upper limit of the ratio of the water to the edible oil can be about 10000:1, preferably about 5000:1, preferably about 3000:1, preferably about 1000:1, preferably about 900:1, preferably about 800:1, preferably about 700:1, preferably about 600:1, preferably about 500:1, or preferably about 400:1, by volume. A desirable ratio of water to edible oil can be obtained by combining a lower limit mentioned above and an upper limit mentioned above. For example, the ratio of water or alkaline water to edible oil can be from about 50:1 to about 5000:1, from about 100:1 to about 1000:1, from about 200:1 to about 1000:1, or from about 200:1 to about 900:1, by volume.

As illustrated above, the high ratio of water to edible oil selected in present invention can limit the using amount of edible oil to a very low level. The reduced using amount of edible oil may be beneficial to health. On the other hand, as demonstrated in the present invention, the dissolution or extraction of fat-soluble nutrient in water is not impaired due to the presence of surfactants.

According to an embodiment, in the method of present invention, after the surfactant-containing water is generated, a step of adjusting 13 the pH of the surfactant-containing water to a predetermined range is conducted.

With respect to the “predetermined range” mentioned above for pH, it can be any pH range that is desirable. For example, those skilled in the art can determine a desirable range according to actual requirements. It is known that the safe pH range of water for human being is between about 6.5 and about 8.5. Thus according to an embodiment, said predetermined range for pH is from about 6.5 to about 8.5.

As understood by those skilled in the art, in the method of present invention, if the surfactant-containing water obtained in the step of mixing 12 already has a pH within said predetermined range, the step of adjusting 13 the pH of the surfactant-containing water can be omitted.

The pH adjustment mentioned above can be performed with alkaline water, a food or drink compatible basic substance, acidic water and/or a food or drink compatible acidic substance. According to an embodiment, the alkaline water or the food or drink compatible basic substance can be those mentioned above with respect to the pH increasing step 11. According to another embodiment, the food or drink compatible acidic substance can be selected from acetic acid, lactic acid, citric acid or a combination thereof. However, as will be understood by those skilled in the art, generally any food or drink compatible basic and acidic substance can be used provided they can adjust pH to the predetermined range.

According to an embodiment, the acidic water mentioned above can be generated by adding a food or drink compatible acidic substance, for example those mentioned above, into water. According to a particular embodiment, the acidic water is vinegar. According to another embodiment, the acidic water is generated by means of electrolysis of water. The method of present invention can use acidic water produced by any suitable devices for electrolyzing water, provided the acidic water has a desired pH so as to adjust pH to the predetermined range.

According to an embodiment, in the method of present invention, the alkaline water and the acidic water are both generated by means of electrolysis of water.

According to an embodiment, the method of present invention further comprises a step of combining 14 the surfactant-containing water and a substance containing fat-soluble nutrient to produce (i.e. cook, prepare) food or drink, after the pH adjusting step 13.

In an embodiment of present invention, the production of food or drink can include heating. In another embodiment, the production of food or drink can include cooking. For example, the surfactant-containing water prepared in the method of present invention can be used to cook food. There are no particular limits to the procedures of producing food or drink, provided that the surfactant-containing water of present invention is used during the procedures to make food or drink.

The above mentioned fat-soluble nutrient-containing substance can be any raw material that can be used for making food or drink. For example, the fat-soluble nutrient-containing substance can include, but not limited to, meats, fishes, corns, vegetables, fruits, products thereof and so on. Said raw material can be treated (for example cooked) by the surfactant-containing water prepared in the method of present invention so as to promote the dissolution and/or extraction of fat-soluble nutrient into water. The surfactants present in the water can facilitate the dissolution and/or extraction of the fat-soluble nutrient into water.

In another embodiment, as will be understood by those skilled in the art, the fat-soluble nutrient-containing substance can also be raw materials which generally are not used for making food or drink. For example, the fat-soluble nutrient-containing substance can be a plant or a part thereof. For example, the plant may be a medicinal herb. In such a case, the method of present invention can be used to dissolution and/or extraction fat-soluble nutrient from these plants, for example medicinal herbs.

Although the raw material mentioned above for food or drink is described as a fat-soluble nutrient-containing substance, it does not mean that the substance contains only fat-soluble nutrient. As will be understood by a person skilled in the art, the fat-soluble nutrients-containing substance can also contain water soluble nutrient in addition to fat-soluble nutrient. In some cases, the content of the water soluble nutrient in the substance may be higher than that of fat-soluble nutrient.

In the context of present invention, said fat-soluble nutrient can include any fat-soluble nourishing ingredient(s) and/or fat-soluble beneficial ingredient(s). The term “nutrient” has the common meaning in the art. For example, the fat-soluble nutrient can include, but not limited to, phospholipids, cholesterols, carotenes, lycopene, fat-soluble vitamins such as vitamin A, vitamin D, vitamin E and vitamin K, derivatives thereof, or a combination thereof. It should be understood that although the term “nutrient” is used in context of present invention, the method of present invention can also be used to facilitate the dissolution and/or extraction of other fat-soluble ingredients.

According to an embodiment, in the method of present invention, the step of combining 14 the surfactant-containing water and a substance containing fat-soluble nutrient to produce (i.e. cook, prepare) food or drink can be conducted before the step of adjusting pH to the predetermined range. That is, the surfactant-containing water generated is directly combined with substance containing fat-soluble nutrient to produce (i.e. cook, prepare) food or drink and then the pH of the produced food or drink can be adjusted to a predetermined range. As will be understood by those skilled in the art, in the method of present invention, if the produced food or drink already has a pH within said predetermined range, the step of adjusting pH can be omitted.

According to an embodiment, the method of present invention further comprises a step 15 of removing excess oil floated on the surfactant-containing water before the step 14 of combining the surfactant-containing water and the substance containing the fat-soluble nutrient. After such a removing step, the edible oil floated on water is removed to further reduce the amount of left oil. For example, the step of removing 15 excess oil can be conducted after the generation of the surfactant-containing water and before the step of adjusting 13 the pH of the surfactant-containing water or can be conducted after the step of adjusting 13 the pH of the surfactant-containing water and before the step of combining 14 of the surfactant-containing water and the substance containing the fat-soluble nutrient.

Although the method of present invention is described to be capable of increasing the solubility of fat-soluble nutrient in water, as will be understood by those skilled in the art, the surfactant-containing water produced by the method of present invention can also promote the dissolution of species which are water-soluble. For example, the method of present invention can increase the solubility of species have a low solubility in water.

As illustrated by FIG. 1, the method comprises steps 11, 12, 13 and 14. In step 11, the pH of water is increased to generate alkaline water with a pH of at least about 8.0. For example, as described above, the alkaline water can be generated by electrolyzing the water or adding a food or drink compatible basic substance into the water. The obtained alkaline water is then mixed with an edible oil to generate surfactant-containing water in step 12. The surfactant-containing water can be generated as described above. In the next step 13, the pH of the surfactant-containing water is adjusted to a predetermined range. For example, the pH may be adjusted to from about 6.5 to about 8.5. Then the surfactant-containing water obtained after step 13 is combined with substance containing fat-soluble nutrient to produce (i.e. cook, prepare) food or drink in step 14.

Thus, according to an embodiment of present invention, the method of increasing the solubility of fat-soluble nutrient in water of present invention comprises the steps of:
increasing the pH of water to generate alkaline water with a pH of at least about 8.0;
mixing the alkaline water with an edible oil to generate surfactant-containing water;
adjusting the pH of the surfactant-containing water to a predetermined range; and
combining the surfactant-containing water and substance containing the fat-soluble nutrient to produce (i.e. cook, prepare) food or drink.

According another embodiment of present invention, a preferable method of increasing the solubility of fat-soluble nutrient in water of present invention is illustrated in FIG. 2.

The method presented in FIG. 2 comprises steps 21, 22, 23 and 24. In step 21, water is electrolyzed to generate alkaline water and acidic water. For example, the electrolysis of water can be carried out via an electrolyzer. The alkaline water generated in step 21 is mixed with an edible oil in step 22 to generate surfactant-containing water. Of course, the mixing can be conducted under proper conditions, for example those conditions mentioned above, so as to provide the surfactant-containing water. In step 23 the acidic water generated in step 21 is then used to adjust the pH of the surfactant-containing water generated in step 22 to a predetermined range. For example, the pH may be adjusted to from about 6.5 to about 8.5. Next, the surfactant-containing water obtained in step 23 is combined with substance containing fat-soluble nutrient to produce (i.e. cook, prepare) food or drink in step 24.

In another aspect of present invention, the present invention provides an apparatus for implementing the methods according to the present invention.

According to an embodiment of present invention, an apparatus 30 for increasing the solubility of fat-soluble nutrient in water is provided, comprising:
a vessel 31 for mixing alkaline water having pH of at least about 8.0 with an edible oil to generate surfactant-containing water;
a pH controlling unit 32 comprising a processor 33 and a pH meter 34; and
a first controller 35 connected to the pH controlling unit 32 for controlling the supply of acidic water, alkaline water, a food compatible acidic substance and/or a food compatible basic substance into the vessel 31.

In general, the processor 33 may be responsible for the operation of the apparatus. For example, the processor 33 can execute software or codes stored for implementing the method of present invention. For example, the processor 33 can be a general-purpose processor or a special-purpose processor. Examples include microprocessors, microcontrollers, DSP processors, digital signal processors, embedded microprocessors, and controller circuitry, processor circuitry and other circuitry that can execute software or codes. According to an embodiment, the processor can be a single-chip or multi-chip microprocessor.

As will be understood by those skilled in the art, according an embodiment of present invention, using the apparatus of present invention, the method of present invention can be implemented in software, hardware, firmware or any combination thereof.

A predetermined pH range, for example a pH range of from 6.5 to 8.5, can be included in the software or codes in advance. Alternatively, in an embodiment of the apparatus of present invention, an input unit may be included in the apparatus. Thus a desirable pH range can be input through the input unit by a user.

In the apparatus of present invention, the alkaline water and the edible oil are mixed in the vessel 31. According to an embodiment, a stirrer may be further included to stir the water-oil mixture in the vessel 31. According to another embodiment, the apparatus 30 can further comprise a heater to heat the water-oil mixture to a desired temperature.

There are no particular limits to the pH meter 34 used in the apparatus 30 of present invention. A person skilled in the art can easily and properly select the pH meter 34. According to an embodiment, the measured pH value is delivered to the processor 33 to determine if it is within the desirable range. If the pH value measured is not within the desirable range, the processor 33 will initiate a pH adjusting procedure to make the pH fall in the required range.

According to an embodiment, in the apparatus 30 of present invention, the supply of acidic water, alkaline water, a food compatible acidic substance or a food compatible basic substance into the vessel 31 is controlled by the first controller 35.

For example, the pH meter 34 measures the pH and the measured result is sent to the processor 33. The processor 33 determines if the detected pH is between the desired pH range (for example, from about 6.5 to about 8.5 or at least about 8.0). If the detected pH value is higher than the upper limit of desired range, the first controller 35 will, under the control of the processor 33, supply acidic water or food or drink compatible acidic substance into the vessel 31 to decrease the pH. If the detected pH value is lower than the lower limit of the desired range, the first controller 35 will, under the control of the processor 33, introduce alkaline water or food or drink compatible basic substance into the vessel 31 to increase the pH. There are no particular limits to the first controller 35, provided that it can control the supply of acidic water, alkaline water, a food compatible acidic substance or a food compatible basic substance. According to an embodiment, the first controller 35 can be a valve, for example an electric valve or motor valve.

According to an embodiment, the apparatus 30 of present invention can further comprise a water electrolyzer for generating alkaline water and acidic water. Any water electrolyzer known in the art can be used, provided that the water electrolyzer can provide the desired alkaline water and acidic water.

According to an embodiment, the apparatus 30 can further comprise a first reservoir for acidic water. The water electrolyzer can generate both alkaline water and acidic water at the same time. The alkaline water is fed into the vessel 31 to mix with edible oil, and the acidic water can be stored in the first reservoir. The stored acidic water can be used to adjust the pH in the method of present invention.

According to another embodiment, the apparatus 30 of present invention can further comprise a second reservoir for the alkaline water. According to a further embodiment, the apparatus 30 of present invention further comprises a third reservoir for the edible oil and a third controller to control the supply of the edible oil into the vessel 31.

According to an embodiment, an apparatus 30 of present invention is illustrated in FIG. 3. This apparatus 30 includes a vessel 31 for mixing alkaline water and an edible oil to generate surfactant-containing water. The apparatus 30 further comprises a pH controlling unit 32. This pH controlling unit 32 includes a processor 33 and a pH meter 34. The pH meter 34 measures the pH of the mixture in the vessel 31 and delivers the measured pH value to processor 33. The processor 33 receives the delivered pH value and determines if the pH value is within desirable range. If the measured pH value is not within the desired range, the processor 33 will control the first controller 35 to introducing acidic water, alkaline water, a food compatible acidic substance or a food compatible basic substance into the vessel 31.

According to a preferable embodiment of present invention, an apparatus 30 for increasing the solubility of fat-soluble nutrient in water is provided, comprising:
a water electrolyzer to generate alkaline water and acidic water;
a vessel 31 for mixing alkaline water having pH of at least about 8.0 with an edible oil to generate surfactant-containing water;
a pH controlling unit 32 comprising a processor 33 and a pH meter 34; and
a first controller 35 connected to the pH controlling unit 32 for controlling the supply of acidic water, alkaline water, a food compatible acidic substance and/or a food compatible basic substance into the vessel 31.

### EXAMPLES

The present invention will be described in more detail by way of specific examples. However, the present invention is not limited to these examples.

### Example 1

Into a 500 mL beaker, olive oil and water having a pH of 8.65 was added in a ratio of oil/water=1:100 by volume (1 mL oil and 100 mL water). The alkaline water having a pH of 8.65 was obtained by adding NaHCO₃ into neural pure water. The mixture of the olive oil and the alkaline water was heated to 90° C. at atmospheric pressure while gently stirred by a magnetic stirrer. The mixture was heated at 90° C. under stirring for 30 minutes and then the mixture was cooled to room temperature. The unreacted oil on the surface of water, if any, was removed carefully. Then enough oil orange powder (CAS No. 3118-97-6; a fat-soluble pigment, not soluble in water at all. From Sinopharm Chemical Reagent Co., Ltd, China) was added into the cooled water. The water with oil orange was then ultrasonic processed for 10 minutes. The resulted mixture was filtered through a 0.45 μm membrane to remove undissolved oil orange particles. The absorbance of the resulted filtrate was measured by a spectrophotometer (DR 5000™ UV-Vis Spectrophotometer, from Hach Company) at wavelength of 695 nm and reported in table 1 below.

### Example 2

Example 1 was repeated except that water having a pH of 10 (adjusted by NaOH) was used. The absorbance of the resulted filtrate was measured and reported in table 1 below.

### Example 3

Example 1 was repeated except that water having a pH of 11 (adjusted by NaOH) was used. The absorbance of the resulted filtrate was measured and reported in table 1 below.

### Example 4

Example 1 was repeated except that water having a pH of 12 (adjusted by NaOH) was used. The absorbance of the resulted filtrate was measured and reported in table 1 below.

### Comparative Example 1

Example 1 was repeated except that neutral pure water was used. The absorbance of the resulted filtrate was measured and reported in table 1 below.

TABLE 1
absorbance at 695 nm:

| | pH value of water | Absorbance |
|---|---|---|
| Example No. | (before mixing with oil) | at 695 nm |
| Example 1 | 8.65 | 0.099 |
| Example 2 | 10 | 0.129 |
| Example 3 | 11 | 0.108 |
| Example 4 | 12 | 0.190 |
| Comparative example 1 | 7.0 | 0.008 |

The absorbance results in table 1 clearly showed that the use of alkaline water did increase the solubility of oil orange in water. It can be see that the solubility of oil orange in water increases with the increasing of pH of water, as indicated by greater absorbance at 695 nm. It is believed that more surfactants can be generated at higher pH of water, which in turn results in a greater solubility of oil orange.

### Example 5

Example 1 was repeated except that water having a pH of 8 (adjusted by NaHCO₃) was used. The absorbance of the resulted filtrate was measured and reported in table 2 below.

### Example 6

Into a 500 mL beaker, olive oil and water having a pH of 13 was added in a ratio of oil/water=1:100 by volume (1 mL oil and 100 mL water). The alkaline water having a pH of 13 was obtained by adding NaOH into neural pure water. The mixture of the olive oil and alkaline water was heated to 90° C. while gently stirred by a magnetic stirrer. The mixture was heated at 90° C. under stirring for 30 minutes and then the mixture was cooled to room temperature. The unreacted oil on the surface of water, if any, was removed carefully. Then enough oil orange powder was added into the cooled water. Then acidic water was added into the water with oil orange to decrease the pH to pH 8. The water with oil orange having a pH of 8 was then ultrasonic processed for 10 minutes. The resulted mixture was filtered through a 0.45 μm membrane to remove undissolved oil orange particles. The absorbance of the resulted filtrate was measured by a spectrophotometer at wavelength of 695 nm and reported in table 2 below.

TABLE 2
the influence of pH adjustment:

| | | Absorbance |
|---|---|---|
| Example No. | pH value of water | at 695 nm |
| Example 5 | 8 (before mixing with oil) | 0.014 |
| Example 6 | 13/8 (before mixing with oil/final pH value) | 1.466 |

As shown in table 2, water with a higher pH value can produce more surfactants and in turn could dissolve more oil orange, though the final pH was adjusted back to a low pH value.

Although the invention has been described in detail with reference to certain embodiments and examples, those skilled in the art will recognize that there are other embodiments within the spirit and the scope of the claims. The scope of the invention should be, therefore, determined with reference to the appended claims, along with the full scope of equivalents to which such claims are entitled.

1. A method of increasing the solubility of fat-soluble nutrient in water, comprising the steps of:
increasing the pH of water to generate alkaline water with a pH of at least about 8.0;
mixing the water with an edible oil to generate surfactant-containing water;
adjusting the pH of the surfactant-containing water to a predetermined range; and
combining the surfactant-containing water and substance containing the fat-soluble nutrient to produce food or drink.

2. The method according to claim 1, wherein the ratio of the water to the edible oil is at least about 50:1 by volume in the step of mixing.

3. The method according to claim 2, wherein the ratio of water to the edible oil is in the range of about 80:1 to about 5000:1 by volume in the step of mixing.

4. The method according to claim 1, wherein the step of mixing is carried out at a temperature of from about 40° C. to boiling temperature.

5. The method according to claim 1, further comprising a step of removing excess oil floated on the surfactant-containing water before the combining of the surfactant-containing water and the substance containing the fat-soluble nutrient.

6. The method according to claim 1, wherein the step of increasing the pH of water comprises:
electrolyzing the water; or
adding a food or drink compatible basic substance into the water;
so as to generate the alkaline water with a pH of at least about 8.0.

7. The method according to claim 6, wherein in the electrolyzing of the water, the alkaline water and an acidic water are generated simultaneously, and wherein the acidic water is used to adjust the pH in the pH adjusting step.

8. The method according to claim 1, wherein the pH adjusting step is implemented by adding an acidic water, an alkaline water, a food or drink compatible acidic substance or a food or drink compatible basic substance.

9. The method according to claim 1, wherein the edible oil is selected from the group consisting of vegetable oil and animal oil; wherein the vegetable oil includes soybean oil, peanut oil, olive oil, corn oil, sunflower seed oil, castor oil, cottonseed oil, coconut oil, rape seed oil, tea-seed oil, coconut oil or a combination thereof, and wherein the animal oil includes lard, tallow, mutton tallow, chicken oil, duck oil, fish oil or a combination thereof.

10. The method according to claim 1, wherein the fat-soluble nutrient is selected from the group consisting of phospholipids, cholesterol, carotenes, lycopene, fat-soluble vitamins, derivatives thereof, and a combination thereof.

11. An apparatus for increasing the solubility of fat-soluble nutrient in water, comprising:
a pH increasing unit for increasing the pH of water to generate alkaline water with a pH of at least about 8.0;
a first controller for controlling the supply of the alkaline water;
a vessel for receiving the alkaline water and mixing the alkaline water with an edible oil to generate surfactant-containing water; and
a pH controlling unit comprising a processor and a pH meter for measuring the pH of the surfactant-containing water;
wherein the first controller is further controlled by the process, for controlling the supply of acidic water, alkaline water, a food or drink compatible acidic substance and/or a food or drink compatible basic substance into the vessel to adjust the pH of the surfactant-containing water to a predetermined range so as to combine the surfactant-containing water and substance containing the fat-soluble nutrient to produce food or drink.

12. The apparatus according to claim 11, wherein the pH increasing unit comprises a water electrolyzer for generating the alkaline water and the acidic water.

13. The apparatus according to claim 11, wherein the apparatus further comprises a heater for heating the vessel.

14. The apparatus according to claim 11, wherein the apparatus further comprises a first reservoir for storing the acidic water and/or a second reservoir for storing the alkaline water.
